(19) United States
(12) Patent Application Publication
(10) Pub. No.: US 2010/0141746 A1
(43) Pub. Date: Jun. 10, 2010

(54) SCANNING ENDOSCOPE PROCESSOR, IMAGE PROCESSOR, AND SCANNING ENDOSCOPE SYSTEM

(75) Inventor: Yuuki IKEDA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/628,321

(22) Filed: Dec. 1, 2009

(30) Foreign Application Priority Data
Dec. 4, 2008 (JP) 2008-309454

(51) Int. Cl. H04N 7/18

(52) U.S. Cl. 348/68; 348/E07.085

(57) ABSTRACT

A scanning endoscope processor, comprising a signal generator, an extractor, a first memory, a second memory, a first connector, and a second connector, is provided. The signal generator generates a pixel signal at a constant cycle according to an amount of reflected light or fluorescence. The extractor extracts extracted pixel signals from the pixel signals that are generated by the signal generator. The first memory stores a first image signal. The second memory stores a second image signal. The first connector can be connected to a first apparatus. The first apparatus is able to receive the first image signal. The second connector can be connected to the monitor. The second image signal stored in the second memory is transmitted to the monitor via the second connector.

### BACKGROUND OF THE INVENTION

1. Field of the Invention

The present invention relates to a scanning endoscope processor that effectively uses all the pixel signals generated by a scanning endoscope.

2. Description of the Related Art

International Publication No. WO2003/019661 and U.S. Pat. No. 6,294,775 propose a scanning endoscope that scans a subject with light and captures reflected light at points illuminated by the light. In a general scanning endoscope, light for illumination is transmitted through an optical fiber from a stationary incident end to a movable emission end and a scanning operation is carried out by successively moving the emission end of the optical fiber.

In order to scan an entire subject with the light for illumination, the emission end of the optical fiber is moved along a spiral course by vibrating the emission end in two directions, which are perpendicular to each other, while increasing the amplitudes of each direction. In order to vibrate the emission end in a stable manner, the emission end is vibrated in accordance with the resonant frequency of the emission end.

The emission end is moved along the spiral course at a constant angular velocity because the frequencies of the vibrations are equal in both directions. An arc length of movement further away from the center of the spiral course is longer than an arc length of movement near the center during the same time because of the constant angular velocity.

Reflected light is received from the point illuminated with the light for illumination, and pixel signals are generated according to the amount of light received in a certain cycle. One frame of an image signal consists of pixel signals corresponding to points within the scanned area.

A distance between neighboring points, where two pixel signals are successively generated in the cycle as the illuminated point moves spirally at the constant angular velocity, becomes shorter as the points approach the center of the spiral. Accordingly, more pixel signals are generated closer to the center of the spiral.

Among all the generated pixel signals, a subset of pixel signals that correspond to the pixels of a monitor are used for production of an image to be displayed on the monitor. As described above, more pixel signals are generated near the center of the spiral course than at points further away from the center. And, the number of pixel signals near the center of the spiral course is greater than the number of the pixels of the monitor.

Accordingly, the pixel signals necessary for displaying an image on a monitor are extracted from all the generated pixel signals. An image signal that consists of the extracted pixel signals is transmitted to the monitor, where an image corresponding to the received image signal is displayed. In addition, the image signal is stored in a memory. The image signal stored in the memory is used for observing the image later. On the other hand, the pixel signals that are not extracted are deleted without being used.

### SUMMARY OF THE INVENTION

Therefore, an object of the present invention is to provide a scanning endoscope processor that effectively uses the pixel signals that are not used for displaying an image.

According to the present invention, a scanning endoscope processor, comprising a signal generator, an extractor, a first memory, a second memory, a first connector, and a second connector, is provided. The signal generator generates a pixel signal at a constant cycle according to an amount of reflected light or fluorescence. The signal generator receives the reflected light or the fluorescence from a scanning endoscope. The scanning endoscope has an illuminator and a light transmitter. The illuminator illuminates an illumination point with light as the illumination point moves along a spiral course at a constant angular velocity. The extractor extracts extracted pixel signals from the pixel signals that are generated by the signal generator while the illumination point is moved from a start point on the spiral course to an end point on the spiral course. The extracted pixel signals are the pixel signals corresponding to pixels of a monitor. The first memory stores a first image signal. The first image signal consists of both the extracted pixel signals and not-extracted pixel signals that are generated while the illumination point is moved from the start point to the end point. The not-extracted pixel signals are the pixel signals excluding the extracted pixel signals. The second memory stores a second image signal. The second image signal consists of the extracted pixel signals. The first connector can be connected to a first apparatus. The first apparatus is able to receive the first image signal. The first image signal stored in the first memory is transmitted to the first apparatus via the first connector. The second connector can be connected to the monitor. The second image signal stored in the second memory is transmitted to the monitor via the second connector.

According to the present invention, an image processor, comprising a receiver and a signal processor is provided. The receiver receives the first image signal stored in the first memory. The signal processor carries out predetermined signal processing on the first image signal using the non-extracted pixel signals.

### BRIEF DESCRIPTION OF THE DRAWINGS

The objects and advantages of the present invention will be better understood from the following description, with reference to the accompanying drawings in which:

FIG. 1 is a schematic illustration of a scanning endoscope system having a scanning endoscope processor and an image processor of the embodiments of the present invention;

FIG. 2 is a block diagram schematically showing the internal structure of the scanning endoscope processor;

FIG. 3 is an illustration of the illuminated points along the spiral course corresponding to generated pixel signals;

FIG. 4 is an illustration of the illuminated points corresponding to pixel signals extracted by the scan converter;

FIG. 5 is a diagram of the pixel signals for each pixel of the monitor when a normal image is displayed;

FIG. 6 is a diagram of the extracted pixel signals and not-extracted pixel signals for each pixel of the monitor when an enlarged image is displayed;

FIG. 7 is a diagram of the extracted pixel signals for each pixel for the monitor when an enlarged image is displayed;

FIG. 8 is a flowchart illustrating the process of the moving image observation mode carried out by the system controller and the memory controller; and

FIG. 9 is a flowchart illustrating the process for displaying an image carried out by the image processor.

### DESCRIPTION OF THE PREFERRED EMBODIMENTS

The present invention is described below with reference to the embodiment shown in the drawings.

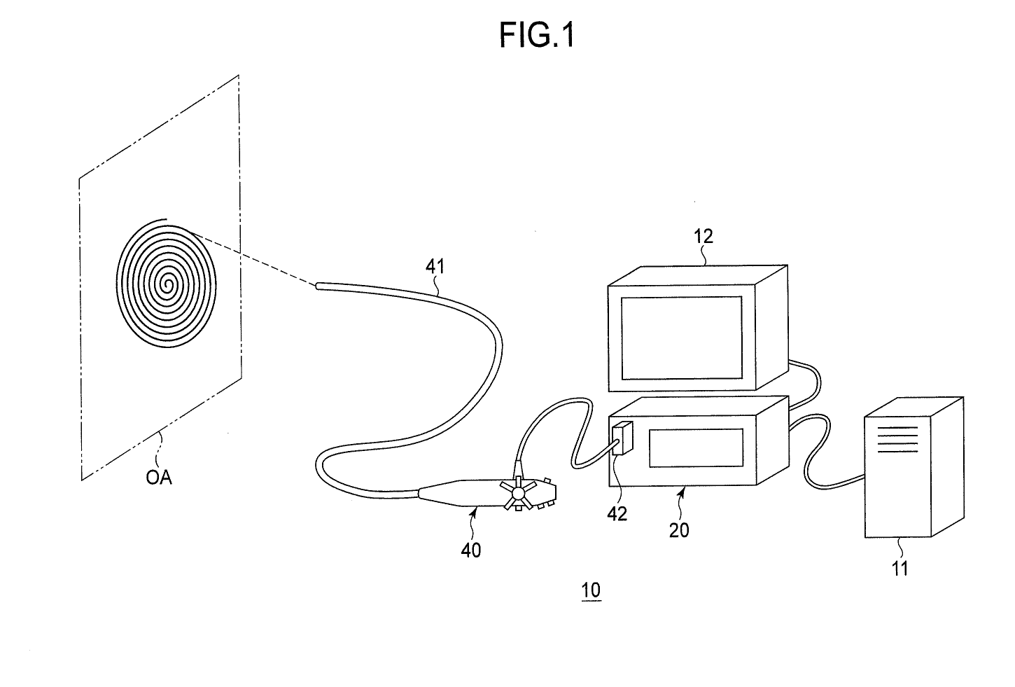

In FIG. 1, a scanning endoscope system 10 comprises a scanning endoscope processor 20, an image processor 11 (first apparatus), a scanning endoscope 40, and a monitor 12. The scanning endoscope processor 20 is connected to the image processor 11, the scanning endoscope 40 and the monitor 12.

Hereinafter, an illumination end of an illumination fiber (not depicted in FIG. 1) and incident ends of image fibers (not depicted in FIG. 1) are mounted in the distal end of the insertion tube 41 of the scanning endoscope 40. In addition, an incident end of the illumination fiber and emission ends of the image fibers are mounted in a connector 42, with which the scanning endoscope processor 20 is connected.

The scanning endoscope processor 20 provides white light that is shined on an observation area (see “OA” in FIG. 1). The white light provided by the scanning endoscope processor 20 is transmitted to the distal end of the insertion tube 41 through the illumination fiber, and is shined towards one point within the observation area. Light reflected from the illuminated point is transmitted from the distal end of the insertion tube 41 to the scanning endoscope processor 20.

The direction of the emission end of the illumination fiber is changed by a fiber actuator (not depicted in FIG. 1). By changing the direction, the observation area is scanned with the white light emitted from the illumination fiber.

The point of illumination within the observation area is moved along a spiral course at a constant angular velocity by vibrating the emission end in two directions that are perpendicular to each other and perpendicular to the axis direction near the emission end of the illumination fiber, while increasing and decreasing the amplitudes of vibration. Accordingly, the velocity of the moving illuminated point increases as the illuminated point is moved farther from the center of the spiral.

Reflected light, which is scattered at the illuminated point, is transmitted to the scanning endoscope processor 20 by the scanning endoscope 40. The scanning endoscope processor 20 generates a pixel signal according to the amount of received light. One frame of an image signal is generated by generating pixel signals corresponding to the illuminated points dispersed throughout the observation area. Namely, one frame of an image signal is generated by generating pixel signals while the illuminated point is moved from a start point on the spiral to an end point on the spiral.

The generated image signal is transmitted to the image processor 11 or the monitor 12. The image processor carries out predetermined image processing on the received image signal. An image corresponding to the received image signal is displayed on the monitor 12.

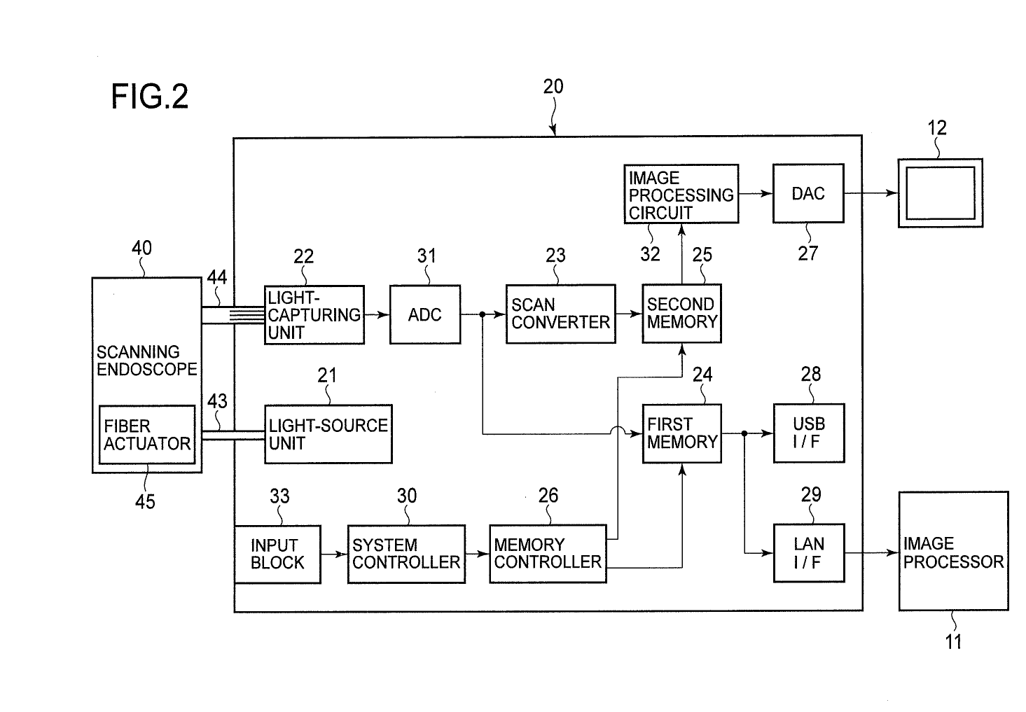

As shown in FIG. 2, the scanning endoscope processor 20 comprises a light-source unit 21, a light-capturing unit (signal generator), a scan converter 23 (extractor), first and second memories 24 and 25, a memory controller 26, a D/A converter 27 (second connector), a USB interface 28 (first connector), a LAN interface 29 (first connector), and other components.

The scanning endoscope 40 comprises the illumination fiber 43 (illuminator), the image fibers 44 (light transmitter), and the fiber actuator 45. The white light for illuminating the observation area is emitted from the light-source unit 21 and is made incident on the incident end of the illumination fiber 43. The white light is emitted toward a point within the observation area from the emission end of the illumination fiber 43 as the emission end is moved by the fiber actuator 45. The light reflected from the illuminated point enters the incident ends of the image fibers 44. The reflected light is transmitted from the incident end to the emission ends of the image fibers 44, and supplied to the light-capturing unit 22.

The light capturing unit 22 comprises red, green, and blue photomultiplier tubes (not depicted) that generates pixel signals according to the amounts of red, green, and blue light components in the reflected light.

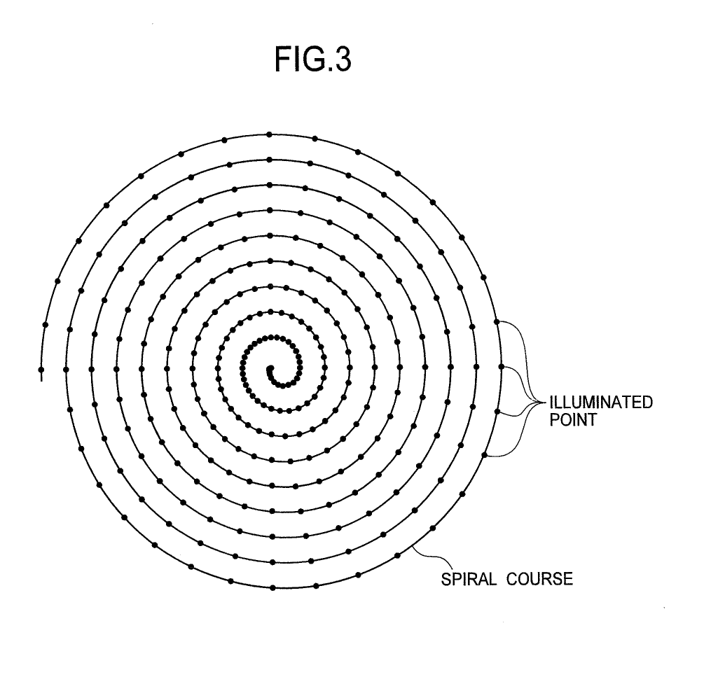

The light-capturing unit 22 is controlled to generate the pixel signals at a constant cycle by the system controller 30. As described above, the pixel signals corresponding to the illuminated point, which is moved at a constant angular velocity along a spiral course, are generated at a constant cycle. Accordingly, as shown in FIG. 3, the number of the illuminated points where the pixel signals (see black dots in FIG. 3) are generated per a certain area decreases as the illuminated points are farther from the center of the spiral.

The number of pixels per a certain area of the monitor 12 is constant in spite of the location on the monitor 12. In order to finely display the whole observation area, the constant cycle for generating the pixel signals is predetermined so that the number of illuminated points corresponding to pixel signals in a certain area located farthest away from the center of the spiral course is consistent with the number of pixels per a certain area of the monitor 12.

The pixel signals generated by the light-capturing unit 22 are digitized by the A/D converter 31. The digitized pixel signals are then transmitted to the first memory 24 and the scan converter 23.

All the received pixel signals are stored in corresponding addresses of the first memory 24. The first memory 24 has enough space to store one frame of an original image signal (first image signal), which consists of all the received pixel signals. The original image signal stored in the first memory 24 is updated with an original image signal of the next frame.

The first memory 24 is connected to the USB interface 28 and the LAN interface 29. The original image signal of the latest frame stored in the first memory 24 can be transmitted to a USB memory (not depicted) and the image processor 11 via the USB interface 28 and the LAN interface 29, respectively.

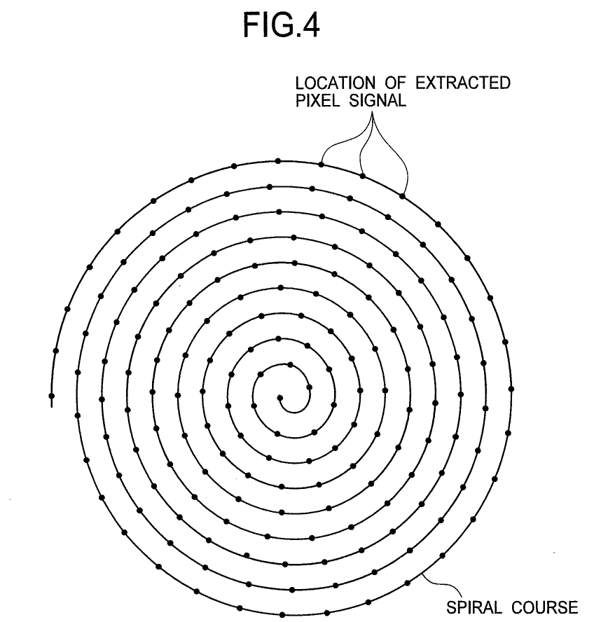

The scan converter 23 extracts a portion of the received pixel signals. The pixel signals that are not extracted are deleted. By generating the pixel signals at the constant cycle as described above, the number of the generated pixel signals near the center of the spiral exceeds the number of pixels on the monitor 12. So, the scan converter 23 extracts only pixel signals (see black dots in FIG. 4) that correspond to the pixels on the monitor 12. In addition, the scan converter 23 performs raster conversion on the extracted pixel signals generated along the spiral course.

The extracted pixel signals that have undergone raster conversion are transmitted to the second memory 25. The received extracted pixel signals are stored in corresponding addresses of the second memory 25. The second memory 25 has enough space to store one frame of an extracted image signal (second image signal), which consists of all the extracted pixel signals. The extracted image signal stored in the second memory 25 is updated with an extracted image signal of the next frame.

After all the extracted pixel signals constituting one frame of an extracted image signal are stored, one frame of the extracted image signal is transmitted to the image processing circuit 32. The image processing circuit 32 carries out predetermined image processing on the extracted image signal. The extracted image signal, after having undergone predetermined image processing, is then converted to an analog signal by the D/A converter 27.

The extracted image signal that has been converted to the analog signal is then transmitted to the monitor 12, where an image corresponding to the extracted image signal is displayed. A moving image is displayed on the monitor 12 by changing the static image for each frame.

The storage and output operations of the first and second memories 24 and 25 are controlled by the memory controller 26. The memory controller 26 is controlled by the system controller 30.

In addition, the system controller 30 controls some operations of the components of the scanning endoscope processor 20. The system controller 30 is connected to the input block 33. On the basis of a command input to the input block 33, the system controller 30 controls certain operations.

The scanning endoscope processor 20 has a moving image observation mode as an operating mode. When the scanning endoscope processor 20 is in the moving image observation mode, a moving image of the observation area is displayed on the monitor 12. When the scanning endoscope processor 20 is in the moving image observation mode, the system controller 30 orders the memory controller 26 to perform a first control for the first and second memories 24 and 25.

In the first control, the pixel signals transmitted from the A/D converter 31 are stored in the first memory 24. In addition, in the first control, the transmission of the original image signal stored in the first memory 24 to either the USB memory or the image processor 11 is suspended.

In addition, in the first control, the extracted pixel signals transmitted from the scan converter 23 are stored in the second memory 25. In addition, in the first control, the extracted image signal updated in the second memory 25 is transmitted to both the image processing circuit 32 and the monitor 12 via the D/A converter 27.

When a command ordering the display of a static image is input to the input block 33 while the moving image is displayed on the monitor 12, the system controller 30 orders the memory controller 26 to perform a second control for the first and second memories 24 and 25.

In the second control, the storage operation of the pixel signals that are transmitted from the A/D converter 31 in the first memory 24 is suspended. In addition, also in the second control, the transmission of the original image signal stored in the first memory 24 to either the USB memory or the image processor 11 is suspended.

In addition, in the second control the storage operation of the extracted pixel signals, which are transmitted from the scan converter 23, in the second memory 25 is also suspended. In the second control, the latest extracted image signal stored in the second memory 25 is repeatedly transmitted to both the image processing circuit 32 and the monitor 12 via the D/A converter 27. Accordingly, an image corresponding to the extracted image signal that is repeatedly transmitted is displayed as a static image on the monitor 12.

The second control terminates when a command to terminate the display of the static image is input to the input block 33. Then, the memory controller 26 performs the first control for the first and second memories 24 and 25 again.

When a command ordering the collection of an image is input to the input block 33 while a static or moving image is displayed on the monitor 12, the system controller 30 orders the memory controller 26 to perform a third control for the first and second memories 24 and 25.

In the third control, the storage operation in the first memory 24 of the pixel signals that are transmitted from the A/D converter 31 is suspended. In addition, in the third control, the latest original image signal stored in the first memory 24 is transmitted to either the USB memory or the image processor 11.

In addition, in the third control, the storage operation in the second memory 25 of the pixel signals that are transmitted from the scan converter 23 is suspended also. In the third control, the latest extracted image signal stored in the second memory 25 is repeatedly transmitted to the monitor 12 via the D/A converter 27 also.

The third control terminates when the original image signal stored in the first memory 24 is transmitted to either the USB memory or the image processor 11. Then, the memory controller 26 performs the first control for the first and second memories 24 and 25 again.

The original image signal, which is transmitted from the first memory 24 in the third control, is stored in either the USB memory or the image processor 11. The image processor 11 carries out predetermined image processing on the stored original image signal. The original image signal stored in the USB memory can be transmitted to other image processors (not depicted).

As described above, the original image signal consists of both the extracted pixel signals and the pixel signals that are not extracted by the scan converter 23. The image processor 11 carries out predetermined image processing using the not-extracted pixel signals.

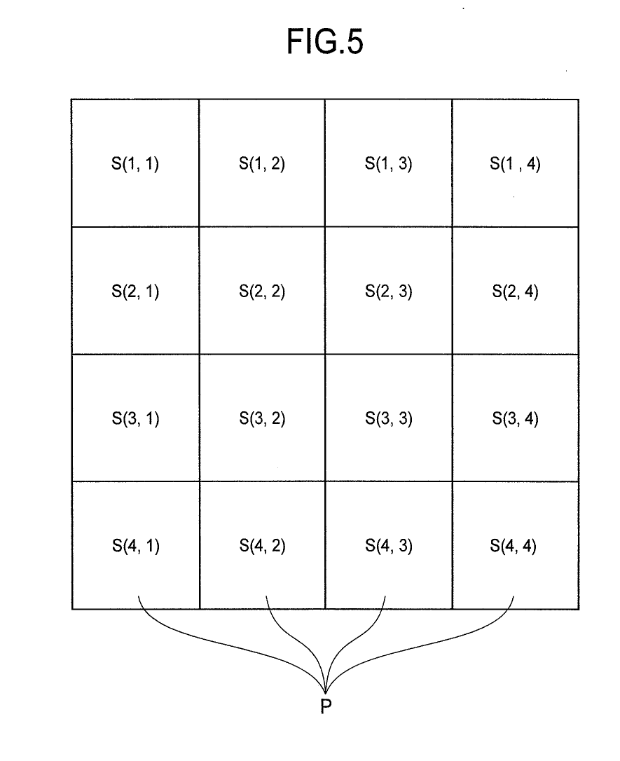

For example, the image processor 11 carries out enlargement processing using the not-extracted pixel signals. The enlargement processing is explained in detail using FIGS. 5-7. In FIGS. 5-7, pixel signals corresponding to 16 pixels arranged in four columns and four rows on the monitor 12 are illustrated. In FIGS. 5-7, the pixel signal corresponding to the pixel arranged in the xth row and yth column is represented as S(x,y).

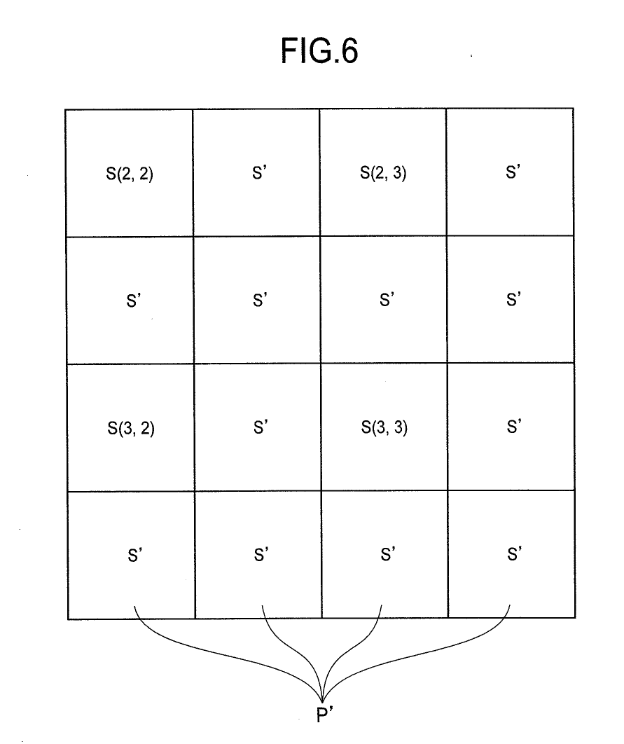

When a normal image is displayed, light is emitted from the pixels (see “P” in FIG. 5) according to the amount of light corresponding to the signal intensities of the extracted pixel signals. On the other hand, when an enlarged image of the center of the normal image with an area that is four times as broad as that of the normal image is displayed, light is emitted from the pixels (see the four pixels that are arranged at the intersections of the first row and first column, first row and third column, third row and first column, and third row and the third column in FIG. 6) located at a predetermined location in groupings of pixels, which have four pixels arranged in two rows and two columns, according to the amounts of light corresponding to the signal intensities of the extracted pixel signals. Further, light is emitted from the other pixels (see “P′” in FIG. 6) according to the amount of light corresponding to the signal intensities of the not-extracted pixel signals (see “S′” in FIG. 6). As shown in FIG. 6, the above-mentioned other pixels P′ are located between two pixels P in every direction, which are located adjacent to each other when the normal image is displayed.

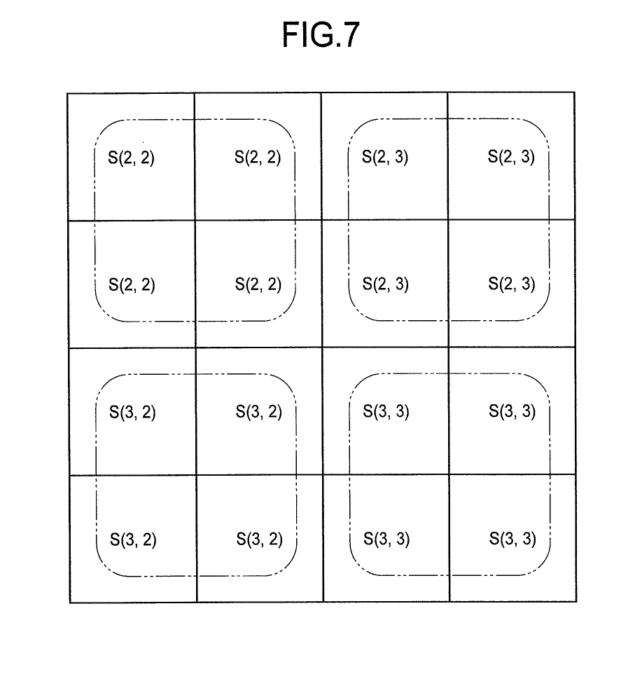

If an image is enlarged by four times using only extracted pixel signals as in a prior art, the number of pixels emitting light at amounts according to a single extracted pixel signal increases from one in displaying the normal image to four in displaying the image enlarged four times (see dashed line in FIG. 7). Accordingly, by enlarging an image using both the extracted pixel signals and the not-extracted pixel signals, an enlarged image with a finer resolution can be displayed on the monitor.

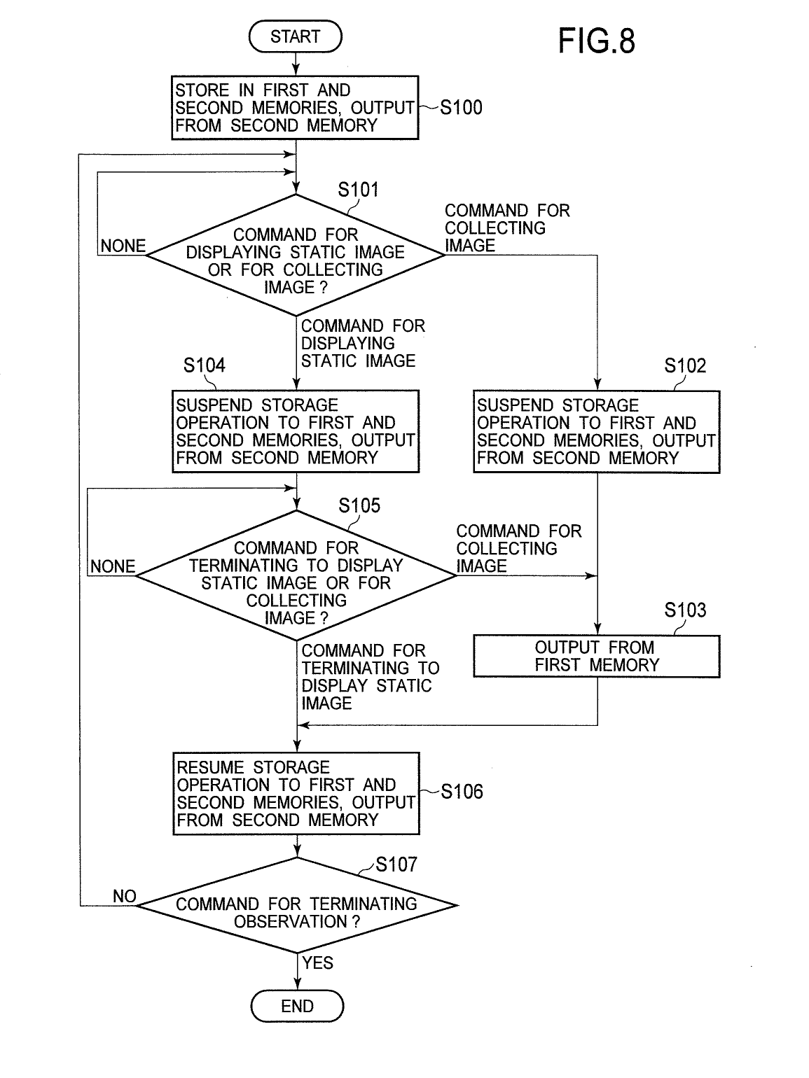

Next, the process of the moving image observation mode, which is carried out by the system controller 30 and the memory controller 26, is explained using the flowchart of FIG. 8. The process of the moving image observation mode commences when the operation mode of the scanning endoscope system 10 is changed to the moving image observation mode.

At step S100, the memory controller 26 performs the first control. In other words, the memory controller 26 orders the first memory 24 to store all the pixel signals transmitted from the A/D converter 31. In addition, the memory controller 26 orders the second memory 25 to store the extracted pixel signals transmitted from the scan converter 23. In addition, the memory controller 26 orders the second memory 25 to output the latest frame of the extracted image signal after the storage operation is finished.

At step S101 following step S100, the system controller 30 determines whether or not a command for either displaying a static image or collecting an image is input to the input block 33. When neither command is input, step S101 is repeated until either command is input.

When the command for collecting an image is input, the process proceeds to step S102. At step S102, the memory controller 26 performs the third control. First, the memory controller 26 suspends the storage operation of the pixel signals to the first and second memories 24 and 25. In addition, the memory controller 26 continues the output operation of the extracted image signal from the second memory 25. Because the update of the extracted image signal in the second memory 25 is suspended, the same extracted image signal is output from the second memory 25, and a static image is displayed on the monitor 12.

After suspending the storage operation of the pixel signals to the first and second memories 24 and 25, the process proceeds to step S103. At step S103, the memory controller 26 orders the first memory 24 to output the original image signal to the USB memory or the image processor 11. After outputting the original image signal, the process proceeds to step S106.

When the command for displaying a static image is input, the process proceeds to step S104. At step S104, the memory controller 26 performs the second control. In other words, the memory controller 26 suspends the storage operation of the pixel signals to the first and second memories 24 and 25. In addition, the memory controller 26 continues the output operation of the extracted image signal from the second memory 25. Because updating the extracted image signal in the second memory 25 has been suspended, the same extracted image signal is output from the second memory 25 and a static image is displayed on the monitor 12.

After suspending the storage operation of the pixel signals to the first and second memories 24 and 25, the process proceeds to step S105. At step S105, the system controller 30 determines whether or not a command for either terminating the static image display or collecting an image is input to the input block 33. When neither command is input, step S105 is repeated until either command is input.

When the command for collecting an image is input, the process proceeds to step S103. Because the second control is performed at step S104, the third control is completed by outputting the original image signal from the first memory 24 in addition to the second control.

When the command for terminating the static image display is input at step S105, or when the output operation of the original image signal at step S103 is completed, the process proceeds to step S106. At step S106, the memory controller 26 performs the first control by commencing the operation that stores the pixel signals to the first and second memories 24 and 25.

To explain in detail, the memory controller 26 orders the first memory 24 to store all the pixel signals transmitted from the A/D converter 31. In addition, the memory controller 26 orders the second memory 25 to store the extracted pixel signals transmitted from the scan converter 23. In addition, the memory controller 26 orders the second memory 25 to output the latest frame of the extracted image signal after the storage operation is finished.

At step S107 following step S106, the system controller 30 determines whether or not the command for terminating the observation is input. When the command for terminating the observation is not input, steps S101 to S107 are repeated. When the command for terminating the observation is input, the process of the moving image observation mode terminates.

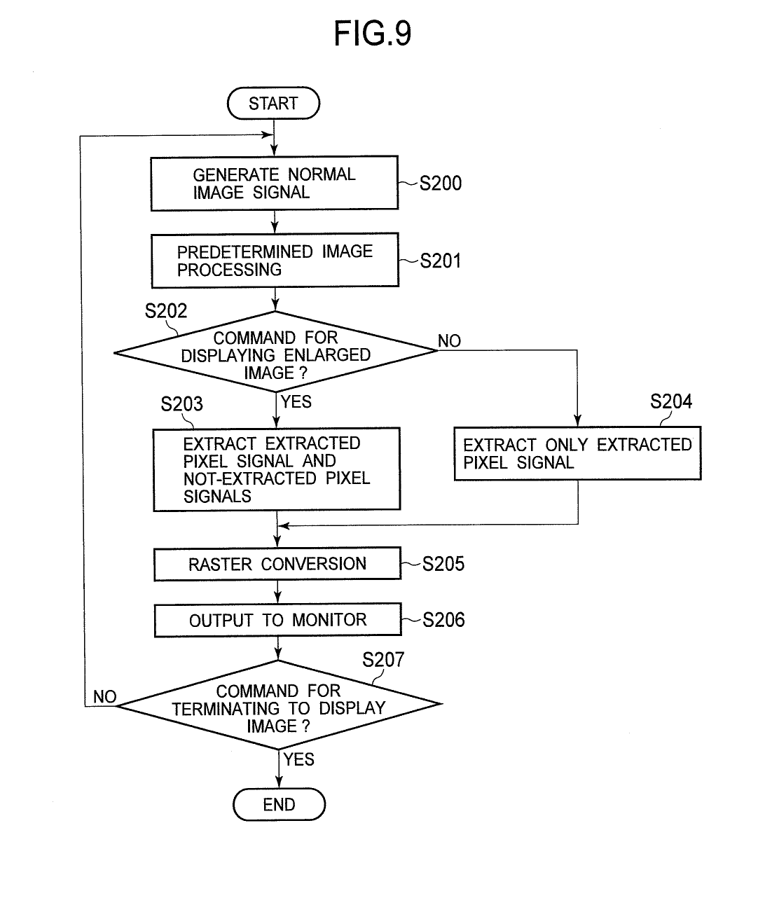

Next, the process for displaying an image carried out by the image processor 11 is explained using the flowchart of FIG. 9. The process for displaying an image commences when an operation mode of the image processor 11 connected to another monitor is changed to a mode for displaying an image.

At step S200, the image processor 11 generates a normal image signal corresponding to the normal image on the basis of the original image signal. After generation of the normal image signal, the process proceeds to step S201.

At step S201, the image processor 11 carries out predetermined image processing, such as white balance processing and luminance adjustment processing, on the generated normal image signal. After predetermined image processing, the process proceeds to step S202.

At step S202, the image processor 11 determines whether or not the command for displaying an enlarged image is input to the input block 33. When the command for displaying an enlarged image is input, the process proceeds to step S203. When the command for displaying an enlarged image is not input, the process proceeds to step S204.

At step S203, the image processor 11 extracts extracted pixel signals and not-extracted pixel signals that correspond to the pixels of the monitor, according to the enlargement magnification. At step S204, the image processor 11 only extracts the extracted pixel signals. After extraction of the necessary pixel signals, the process proceeds to step S205.

At step S205, the image processor 11 carries out raster conversion on the pixel signals extracted in either step S203 or S204. After raster conversion, the process proceeds to step S206.

At step S206, the image processor 11 outputs the image signal that consists of pixel signals having undergone raster conversion to the monitor. Then, either the normal image or the enlarged image is displayed on the monitor. After outputting the image signal, the process proceeds to step S207.

At step S207, the image processor 11 determines whether or not a command has been input for terminating the display of an image. When the command for terminating is not input, the process returns to step S200, and steps S200 to S207 are repeated. When the command for terminating is input, the image ceases being displayed.

In the above embodiment, the original image signal can be stored separately from the extracted image signal that is used for producing a moving image.

In addition, in the above embodiment the not-extracted pixel signals can be used effectively by carrying out image processing on not only the extracted pixel signals but also the not-extracted pixel signals.

The original image signal stored in the first memory 24 is updated with the next frame of the original image signal, in the above embodiment. However, a plurality of original image signals can be stored in the first memory 24 without updating.

The original image signal is output from the first memory 24 when the command for collecting an image is input during the display of either a static or moving image on the monitor 12, in the above embodiment. The condition for outputting the original image signal is not limited to the above. The original image signal may be output from the first memory 24 to another device, such as the image processor 11 and the USB memory, as long as the original image signal is stored in the first memory 24.

The original image signal stored in the first memory 24 is updated whenever a pixel signal is transmitted from the A/D converter 31, in the above embodiment. However, the original image signal does not have to be always updated. For example, the original image signal can be stored only when the command for collecting an image is input. In this case a frame of an original image signal, which is transmitted from the A/D converter 31 soon after the command is input, is stored.

The static image can be displayed in the above embodiment, but it does not have to be displayed. By inputting the command for collecting an image after displaying a static image, as in the above embodiment, the original image signal can be transmitted to the image processor 11 after a user has checked to determine whether or not to store the displayed static image.

The first control resumes after the outputting the original image signal from the first memory 24 has been completed, in the above embodiment. However, the first control may not be resumed. Nonetheless, it is preferable to display a moving image soon after transmitting the original image signal.

The image processor 11 enlarges an image using the not-extracted pixel signals, in the above embodiment. However, the image processor 11 can carry out another image processing operation that not only uses the extracted pixel signals but also the not-extracted pixel signals. By doing so, the not-extracted pixel signals can be used effectively.

The white light is emitted from the light-source unit 21, as in the embodiment. The light-source unit 21 may emit other kinds of light, such as excitation light that excites an organ to fluoresce. Then, autofluorescence (fluorescence) incident on the incident end of the image fibers 44 can be transmitted to the light-capturing unit 22, and the image can be produced on the basis of the autofluorescence.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-309454 (filed on Dec. 4, 2008), which is expressly incorporated herein, by reference, in its entirety.

1. A scanning endoscope processor comprising:
a signal generator that generates a pixel signal at a constant cycle according to an amount of reflected light or fluorescence, the signal generator receiving the reflected light or the fluorescence from a scanning endoscope, the scanning endoscope having an illuminator and a light transmitter, the illuminator illuminating an illumination point with light as the illumination point moves along a spiral course at a constant angular velocity;
an extractor that extracts extracted pixel signals from the pixel signals that are generated by the signal generator while the illumination point is moved from a start point on the spiral course to an end point on the spiral course, the extracted pixel signals being the pixel signals corresponding to pixels of a monitor;
a first memory that stores a first image signal, the first image signal consisting of both the extracted pixel signals and not-extracted pixel signals that are generated while the illumination point is moved from the start point to the end point, the not-extracted pixel signals being the pixel signals excluding the extracted pixel signals;
a second memory that stores a second image signal, the second image signal consisting of the extracted pixel signals;
a first connector that can be connected to a first apparatus, the first apparatus being able to receive the first image signal, the first image signal stored in the first memory being transmitted to the first apparatus via the first connector; and
a second connector that can be connected to the monitor, the second image signal stored in the second memory being transmitted to the monitor via the second connector.

2. A scanning endoscope processor according to claim 1, further comprising a memory controller,
when an operation mode is in a moving image observation mode, the memory controller controlling the first memory so that the first image signal stored in the first memory is updated with the latest first image signal, the moving image observation mode being an operation mode for observing a moving image of a subject illuminated with the light of the illuminator,
when an operation mode is in the moving image observation mode, the memory controller controlling the second memory so that the second image signal stored in the second memory is updated with the latest second image signal, and the updated second image signals are successively transmitted to the monitor via the second connector.

3. A scanning endoscope processor according to claim 2, wherein when a command for displaying a static image is input in the moving image observation mode, the memory controller controls the first and second memory so that updating of the first and second image signals stored in the first and second memories is suspended, respectively, and so that the latest second image signal stored in the second memory is repeatedly transmitted to the monitor via the second connector.

4. A scanning endoscope processor according to claim 2, wherein when a command for collecting a static image is input in the moving image observation mode, the memory controller controls the first and second memory so that updating of the first and second image signals stored in the first and second memories is suspended, respectively, and so that the latest first and second image signals stored in the first and second memories are repeatedly transmitted to the first apparatus and the monitor via the first and second connectors, respectively.

5. A scanning endoscope processor according to claim 4, wherein the memory controller orders the first and second memories to resume updating of the first and second image signals to the first and second memories, respectively, after the completion of the transmission of the latest first image signal stored in the first memory.

6. An image processor that receives the first image signal from a scanning endoscope according to claim 1, the image processor comprising:
a receiver that receives the first image signal stored in the first memory; and
a signal processor that carries out predetermined signal processing on the first image signal using the not-extracted pixel signals.

7. A scanning endoscope system comprising a scanning endoscope processor according to claim 1 and an image processor that receives the first image signal from the scanning endoscope, the image processor comprising:
a receiver that receives the first image signal stored in the first memory; and
a signal processor that carries out predetermined signal processing on the first image signal using the not-extracted pixel signals.
